(19) United States
(12) Patent Application Publication
(10) Pub. No.: US 2005/0176447 A1
(43) Pub. Date: Aug. 11, 2005

(54) Method and communication system for controlling a mobile communication terminal

(76) Inventors: Frank Majewski, Berlin (DE); Franz Steinbacher, Berlin (DE)

Correspondence Address: BELL, BOYD & LLOYD, LLC, P. O. BOX 1135, CHICAGO, IL, 60690-1135, US

(21) Appl. No.: 10/512,163

(22) PCT Filed: Apr. 4, 2003
(86) PCT No.: PCT/DE03/01234

(30) Foreign Application Priority Data
Apr. 19, 2002 (DE) 102 18 807.6

(51) Int. Cl. H04Q 7/20

(52) U.S. Cl. 455/466

(57) ABSTRACT

A method is provided for controlling a mobile communication terminal via at least one external control unit, according to which the at least one control unit generates a control message and transmits the control message to the mobile communication terminal via an air interface via a protocol. The control message is decoded in the mobile communication terminal via a decoding unit and is converted into calls by a call interface which is implemented within the mobile communication terminal, whereby one or several functions is/are triggered in the mobile communication terminal.

### BACKGROUND OF THE INVENTION

External, world-wide access to the functionality of a mobile communication terminal, such as to a mobile telephone, a modem, a radio modem or a wireless module, via an air interface has not been possible, to date, for an external control unit or a controlling computer. At best, such functionality can be provided using an application-specific and customer-specific application which, for its part, needs to be connected to the mobile communication terminal using a local communication interface; for example, using an AT command interface. However, this entails a high level of complexity and, as a result, high levels of cost, since an application-specific and customer-specific application needs to be provided.

It is, thus, an object of the present invention to make it possible for an external control unit or a controlling computer to access the entire scope of functions of a mobile communication terminal as easily and inexpensively as possible.

### SUMMARY OF THE INVENTION

Accordingly, the present invention provides a method for controlling a mobile communication terminal using at least one external control unit, in which:
the at least one control unit generates a control message and transmits the control message to the mobile communication terminal via an air interface using a protocol;
the control message is decrypted in the mobile communication terminal using a decoding unit; and
the control message is converted into calls from a call interface implemented in the mobile communication terminal, as a result of which one or more functions are triggered in the mobile communication terminal.

In one preferred embodiment of the inventive method, the control unit chosen is a controlling computer, also called DTE below. However, worldwide access to the mobile communication terminal is available to any control unit which can send data telegrams using SMS or IP-based communication protocols, such as a mobile telephone (mobile phone) or over the Internet using standard applications, such as an Internet browser like Microsoft Internet Explorer.

In this context, the IP-based communication protocols which may be used are SMTP, HTTP and/or FTP, for example. It is also possible to map information from e-mail or FTP telegrams onto SMS, for example. This may be done on the Internet, with the service provider or in the mobile communication terminal itself using GPRS functionality. In this context, the respective command information contained in the data telegrams, such as in the e-mail format, are copied to a new format; for example, to an SMS.

Preferably, the control message is transmitted using a short message service (SMS) or an IP-based communication protocol. The content of a data telegram transmitted in this manner includes uniquely coded keywords and parameters which are associated with corresponding commands on the call interface.

Preferably, the protocol used for transmitting the control message as an SMS is the GSM protocol, and the protocol used for control messages using an IP-based communication protocol is the GPRS or UMTS protocol. The data telegrams may be transmitted on an application-specific basis using any protocol, for example, even the Bluetooth protocol.

In one preferred embodiment of the inventive method, the call interface used which is implemented in the mobile communication terminal is an SIM Application Toolkit (SAT). This is a call interface in line with ETSI standard GSM 11.14. Using a SAT interface, a mobile communication terminal has actually been controlled to date using an application (SA) running on a SIM card. Generally, not only the SIM application (SA) but also all subscriber-specific data, such as the, subscriber identifier, are stored on a chip card, the “SIM” (Subscriber Identity Module) card, which allows each mobile communication terminal to be used. The use of a SIM card is protected from misuse by an additional identifier. The aforementioned coded keywords and parameters of a transmitted data telegram are clearly assigned to SAT commands in this case.

There are a series of functions which can be triggered on the mobile communication terminal using the SAT interface via an SMS from a control unit or a controlling computer.

In one preferred embodiment of the inventive method, the function triggered is the display of texts and/or function menus on a display on the mobile communication terminal.

In another preferred embodiment of the inventive method, the function triggered is polling for user data.

In a further preferred embodiment of the inventive method, the function triggered is the sending of SS (Supplementary Services), USSD (Unstructured Supplementary Service Data) and/or SMS.

A further function triggered is preferably call setup, namely “mobile originating calls.”

In a further preferred embodiment of the inventive method, the function triggered is polling for information which is dependent on the location of the mobile communication terminal. Thus, it is possible, by way of example, to poll for a “mobile country code” (MCC), a mobile network code (MNC), a location area code (LAC), a cell identifier (cell ID) for the currently used cell and a terminal number IMEI (International Mobile Station Equipment Identity) which is unique to the mobile communication terminal. The control unit or the controlling computer can use this information, inter alia, for location-dependent services (location based services).

The present invention also permits access to data on the mobile communication terminal's SIM card. In line with the present invention, the playback of tones and DTMF (Dual Tone Multi-Frequency) on the mobile communication terminal can be triggered by the control unit.

In a further preferred embodiment of the inventive method, execution of AT commands on the mobile communication terminal can be triggered.

In another embodiment of the inventive method, provision also may be made for a browser with a determinable Internet address to be started on the mobile communication terminal.

Data which are ascertained by the SAT interface are preferably returned to the control unit, again via SMS or IP-based communication protocol. The way in which the data are returned, such as via SMS or IP-based communication protocol, likewise may have been stipulated in the order or control message received by the mobile communication terminal, using an encryption word or a keyword. Alternatively, the return message, preferably the return SMS or response SMS, may be sent to the SMS sender address (originating address) contained in the SMS data.

The present invention also provides a communication system for controlling a mobile communication terminal which has at least the following elements:
a control unit for generating a control message;
an air interface for sending the control message to the mobile communication terminal;
a decoding unit in the mobile communication terminal for decrypting the control message and converting it into calls for an SIM Application Toolkit; and
a call interface implemented in the mobile communication terminal.

This system may be used, in particular, to carry out the inventive method and all of its preferred embodiments.

A fundamental advantage of the present invention can be seen, more than anything, in that a standardized SAT interface already implemented in the known mobile communication terminals may be used to control a mobile communication terminal, or an application connected thereto, using SMS or an IP-based communication protocol.

Examples of applications connected to the mobile communication terminal are:
vending machines, which can be polled remotely for their stock of goods;
taximeters which record and send toll charges which are dependent on the route; and
electricity meters and circuit breakers from electricity supply companies which are polled and controlled centrally.

An example of an application of the present invention which may be mentioned is, by way of example, what is known as automatic “fleet management” for vehicles in a haulage company using location-based services. If a haulage company's vehicles are respectively equipped with mobile communication terminals which allow SAT commands to be called using an SMS, the present invention makes it possible to automate the fleet management of the vehicles. To this end, a haulage control center triggers a particular SAT command, namely a “Provide Local Information,” on all vehicles in question, generally HGVs, and receives the current location data from all of the vehicles in question via returned SMS. The location can be derived, by way of example, from a “mobile country code” (MCC), a mobile network code (MNC), a location area code (LAC), a cell ID for the cell currently being used an a “timing advance.” In this context, timing advance describes the propagation time for the radio signals from the base station to the mobile communication terminal. These data can be used to ascertain the respective positions of the HGVs and to match the routes to changing traffic or order situations.

Additional features and advantages of the present invention are described in, and will be apparent from, the following Detailed Description of the Invention and the Figures.

### DETAILED DESCRIPTION OF THE INVENTION

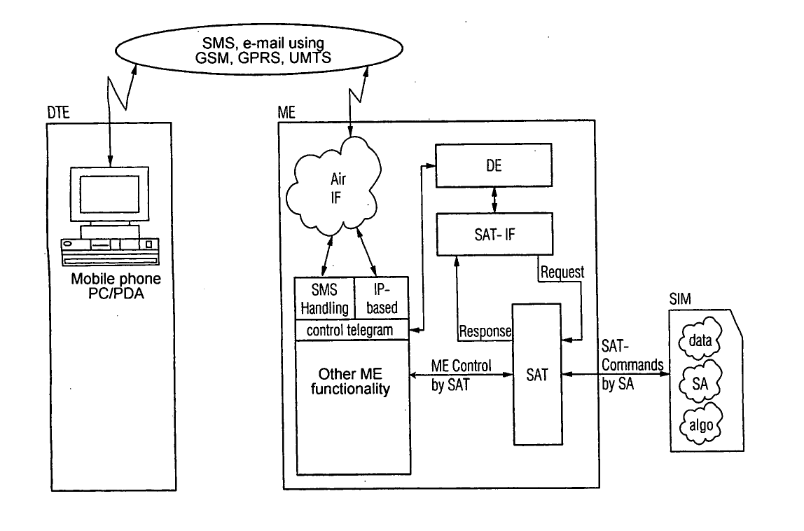

FIG. 1 shows a control unit DTE which is sending a control message (i.e., a data telegram), in the form of an SMS or using an IP-based communication protocol via a GSM, GPRS or UMTS network to a mobile communication terminal ME via an air interface IF. The mobile communication terminal ME uses a decoding unit DE to decrypt the control message and supplies the latter to an SAT (SIM Application Toolkit based on ETSI standard GSM 11.14) protocol stack via an SAT (SIM Application Toolkit) call interface SAT-IF. The control message includes one or more SAT commands and their parameters. SAT calls are then used to trigger desired functions on the ME.

The basic sequence will be explained again below using an exemplary embodiment:

The controlling computer DTE sends an SMS or an e-mail to the mobile communication terminal ME. The data telegram contains the following lines of text:
@@@SAT!@@@
@PROVIDE_LOCAL_INFO@
@RUN_AT_COMMAND, “AT+CREG=0”@

The mobile communication terminal ME checks each incoming data telegram for a unique keyword, in this case @@@SAT!@@@, for example, which flags the fact that the data telegram is intended for the SAT decoding unit DE.

The SAT decoding unit DE interprets the corresponding SAT command and its parameters (in the example, the SAT commands “Provide Local Information” and “Run AT Command”), for every further line of text. The parameter specified for the second SAT command is the character sequence “AT+CREG=0.”

The SAT decoding unit DE prompts the SAT protocol stack to execute the command. The return information from the SAT commands is converted into text and is returned to the controlling computer DTE as a data telegram.

Although the present invention has been described with reference to specific embodiments, those of skill in the art will recognize that changes may be made thereto without departing from the spirit and scope of the present invention as set forth in the hereafter appended claims.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-15. (canceled)

16. A method for controlling a mobile communication terminal using at least one external control unit, the method comprising:
generating, via the at least one external control unit, a control message;
transmitting, via the at least one external control unit, the control message to the mobile communication terminal via an air interface using a protocol;
decrypting the control message in the mobile communication terminal using a decoding unit; and
converting the control message into calls in the mobile communication terminal using a call interface, whereupon at least one function is triggered in the mobile communication terminal.

17. A method for controlling a mobile communication terminal using at least one external control unit as claimed in claim 16, wherein the at least one external control unit is an appliance which can send data telegrams using one of SMS and IP-based communication protocol.

18. A method for controlling a mobile communication terminal using at least one external control unit as claimed in claim 16, wherein the control message is generated using one of a Short Message Service and an IP-based communication protocol.

19. A method for controlling a mobile communication terminal using at least one external control unit as claimed in claim 16, wherein the protocol used for transmitting the control message is one of Bluetooth, GSM, GPRS and UMTS.

20. A method for controlling a mobile communication terminal using at least one external control unit as claimed in claim 16, wherein the call interface implemented in the mobile communication terminal is an SIM Application Toolkit.

21. A method for controlling a mobile communication terminal using at least one external control unit as claimed in claim 16, wherein the at least one function triggered is a display of at least one of text and function menus on a display on the mobile communication terminal.

22. A method for controlling a mobile communication terminal using at least one external control unit as claimed in claim 16, wherein the at least one function triggered is polling for user data.

23. A method for controlling a mobile communication terminal using at least one external control unit as claimed in claim 16, wherein the at least one function triggered is a sending of one of SS, USSD, and SMS.

24. A method for controlling a mobile communication terminal using at least one external control unit as claimed in claim 16, wherein the at least one function triggered is call setup.

25. A method for controlling a mobile communication terminal using at least one external control unit as claimed in claim 16, wherein the at least one function triggered is polling for information local to the mobile communication terminal.

26. A method for controlling a mobile communication terminal using at least one external control unit as claimed in claim 16, wherein the at least one function triggered is access to data on an SIM card of the mobile communication terminal.

27. A method for controlling a mobile communication terminal using at least one external control unit as claimed in claim 16, wherein the at least one function triggered is at least one of a playback of tones and DTMF on the mobile communication terminal.

28. A method for controlling a mobile communication terminal using at least one external control unit as claimed in claim 16, wherein the at least one function triggered is a triggering of AT commands on the mobile communication terminal.

29. A method for controlling a mobile communication terminal using at least one external control unit as claimed in claim 16, wherein the at least one function triggered is a starting of a browser with a determinable Internet address on the mobile communication terminal.

30. A communication system for controlling a mobile communication terminal, comprising:
a control unit for generating a control message;
an air interface for sending the control message from the control unit to the mobile communication terminal;
a decoding unit in the mobile communication terminal for decrypting the control message; and
a call interface in the mobile communication terminal for converting the control message into calls for an SIM Application Toolkit.
